(19) United States
(12) Patent Application Publication
(10) Pub. No.: US 2004/0093982 A1
(43) Pub. Date: May 20, 2004

(54) Electromagnetic propulsion system

(76) Inventor: Tom Prendivoj, Missisauga (CA)

Correspondence Address: Tom Prendivoj, 1817 The Chase, Mississauga, ON, L5M 2Y8, CA

(21) Appl. No.: 10/368,213

(22) Filed: Feb. 20, 2003

(30) Foreign Application Priority Data
Apr. 3, 2002 (CA) 2,379,260

(51) Int. Cl. F16H 35/00

(52) U.S. Cl. 74/840

(57) ABSTRACT

The electromagnetic propulsion system or E.P.S. is a rocketless propulsion engine known as a spacedrive. It is rocketless in that it does not involve the expulsion of propellent. It achieves this by reusing the propellent over and over again by having it travel in a loop or circle. The propellent is propelled with the use of electromagnets. The entire propulsion system moves in the opposite direction of the accelerated propellent.

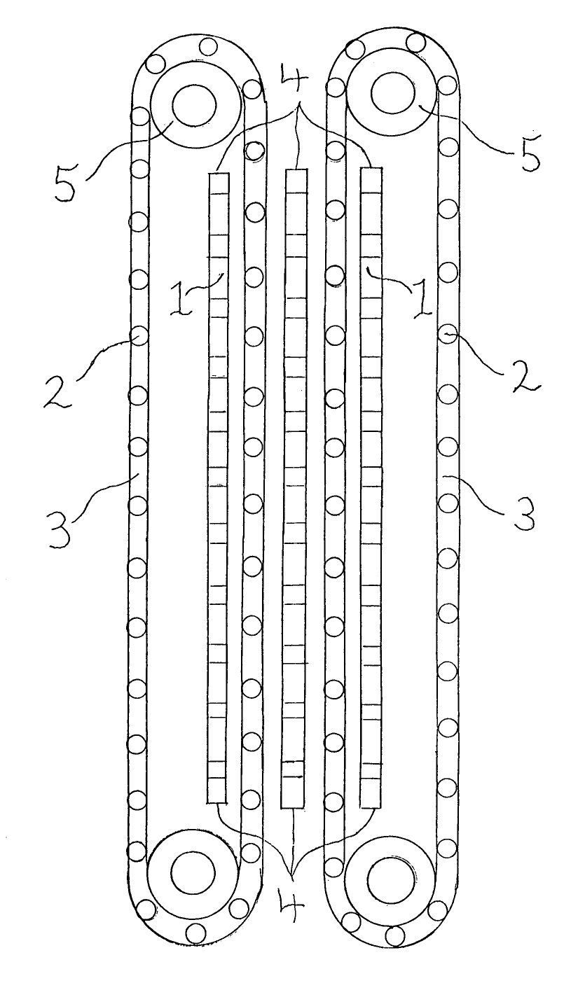

The Electromagnetic Propulsion System or E.P.S. is a rocketless propulsion engine or space drive. It does not consume propellent.

All other propulsive devices (rockets) have always expelled the propellent out of the engine and therefore could not reuse the propellent. The E.P.S. engine however is designed to reuse the propellent by having it travel in a loop. This would be a great advantage since it would then be able to produce a constant acceleration for as long as there is a power source available.

It should also be noted that the thrust is unidirectional because the propellent is accelerated in one direction only. The entire engine moves in the opposite direction of the propelled magnets which are pushed away by the electromagnets. This device conforms fully to Newton's laws of motion.

This engine is best suited for spacecraft and satellites. It would allow spacecraft to achieve incredible velocities. The spacecraft involved would include planetary probes, orbital transfer vehicles, a mission to Mars or even an interstellar probe. This invention could have enormous implications.

### DESCRIPTION OF THE DRAWING

The engine illistrated features electromagnets 1 which propel the permanent magnets 2 that are used as propellent. The permanent magnets are attached to a belt 3 and the two belts shown are held in place by four hubs or wheels 5. There are three sets of electromagnets 4 which are fixed to the engine casing and do not move. The moving parts of the engine consist of the two belts 3 with it's permanent magnets and four wheels 5. The entire engine will move in the direction opposite of the accelerated propellent.

The embodiments of the invention in which an exclusive property or privilage is claimed are defined as follows:

1. A propulsion engine where the propelled matter is reused over and over again by having it travel in a loop or circle.

2. Any device where a wheel or spin is used to transport and reuse the propellent within the confines of the engine it'self where the propellent is a functional fixed part of the engine. This is to include variations of the original propulsive device as illistrated in the drawing.
